(19) United States
(12) Patent Application Publication
(10) Pub. No.: US 2022/0131209 A1
(43) Pub. Date: Apr. 28, 2022

(54) Thermal Management of Battery Modules

(71) Applicant: 3M INNOVATIVE PROPERTIES COMPANY, St. Paul, MN (US)

(72) Inventors: Brandon A. Bartling, Woodbury, MN (US); Bamidele O. Fayemi, Cottage Grove, MN (US); Tyler S. Matthews, Apple Valley, MN (US)

(21) Appl. No.: 17/423,142

(22) PCT Filed: Jan. 20, 2020
(86) PCT No.: PCT/IB2020/050415

§ 371 Date: Jul. 15, 2021

Related U.S. Application Data
(60) Provisional application No. 62/794,873, filed on Jan. 21, 2019.
(60) Provisional application No. 62/928,718, filed on Oct. 31, 2019.

(51) Int. Cl. H01M 10/6556; H01M 50/507; H01M 50/204; H01M 10/613; H01M 10/615; H01M 10/6568; H01M 50/249; H01M 50/543; H01M 10/625

(52) U.S. Cl. CPC H01M 10/6556; H01M 50/507; H01M 50/204; H01M 10/613; H01M 2220/20; H01M 10/6568; H01M 50/249; H01M 50/543; H01M 10/625; H01M 10/615

(57) ABSTRACT

A battery module includes a plurality of electrochemical cells, each with a pair of electrical terminals, a first elongated member, electrically connecting a first terminal of at least one cell of the electrochemical cells to a second terminal of at least one other cell, and a second elongated member, electrically connecting a third terminal of at least one of the cells to a fourth terminal of at least one other cell, wherein at least a portion of the first and second elongated members is a hollow section defining a fluid pathway configured to transmit a fluid for transferring heat to or from the electrical terminals of the electrochemical cells.

### SUMMARY

In some aspects of the present description, a battery module is provided, including a plurality of electrochemical cells, a first elongated member, and a second elongated member. Each cell of the plurality of electrochemical cells including a pair of terminals, connected to an anode and cathode of the cell, respectively. The first elongated member electrically connects a first terminal of at least one cell of the plurality of electrochemical cells to a second terminal of at least one other cell of the plurality of cells, and the second elongated member electrically connects a third terminal of at least one cell of the plurality of electrochemical cells to a fourth terminal of at least one other cell of the plurality of cells. At least a portion of at least one of the first and second elongated members comprises a hollow section, the hollow section defining a fluid pathway configured to transmit a fluid for transferring heat to or from to at least one of the pair of terminals of at least one of the plurality of electrochemical cells.

In some aspects of the present description, an electrical power system is provided, including a plurality of electrochemical cells, a first elongated member, a second elongated member, a fluid pump, and a heat exchanger. Each cell of the plurality of electrochemical cells includes a pair of terminals, connected to an anode and cathode of the cell, respectively. The first elongated member defines a first electrical connection between a first terminal of at least one cell of the plurality of electrochemical cells and a second terminal of at least one other cell of the plurality of cells. The second elongated member defines a second electrical connection between a third terminal of at least one cell of the plurality of electrochemical cells and a fourth terminal of at least one other cell of the plurality of cells. At least a portion of at least one of the first and second elongated members comprises a hollow section, the hollow section defining a fluid pathway with the fluid pump and the heat exchanger.

In some aspects of the present invention, an electric power module is provided, including at least one electrochemical cell including a first terminal and a second terminal, a first electrically conductive member coupled to the first terminal, and a second electrically conductive member coupled to the second terminal. At least a portion of at least one of the first electrically conductive member and the second conductive member comprises a hollow section which defines a fluid pathway configured to transmit a fluid for transferring heat to or from at least one of the first and second terminals.

### BRIEF DESCRIPTION OF THE DRAWINGS

FIG. 1 is a perspective view of an electrical connection with an integral fluid conduit, in accordance with an embodiment described herein;

FIG. 2 is a perspective view of a battery module, in accordance with an embodiment described herein;

FIG. 3 is a perspective view of a battery module with electrical connections, in accordance with an embodiment described herein;

FIG. 4 is a perspective view of an electrochemical cell with C-shaped connection points, in accordance with an embodiment described herein;

FIG. 5 is a perspective view of battery module with hollow cylindrical electrical connections, in accordance with an embodiment described herein;

FIG. 6 is a top view of battery module featuring electrical connections with integral fluid conduits, in accordance with an embodiment described herein;

FIG. 7 is a perspective view of an electrical connection with alternating electrically conductive and electrically insulating sections, in accordance with an embodiment described herein;

FIGS. 8A-8B provide a prospective view and top view, respectively, of a battery module featuring electrical connections with integral fluid conduits, in accordance with an embodiment described herein;

FIG. 9 is a top view of a battery module featuring electrical connections with integral fluid conduits and alternating conductive and insulating sections, in accordance with an embodiment described herein;

FIG. 10 is a block diagram of an electrical power system featuring electrical connections with integral fluid conduits, in accordance with an embodiment described herein; and

FIG. 11 is a perspective view of a battery module with electrical connections, in accordance with an alternate embodiment described herein.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some aspects of the present description, a battery module includes a plurality of electrochemical cells, a first elongated member, and a second elongated member. An electrochemical cell, as defined herein, is a device which can generate electrical energy from a chemical reaction. Each electrochemical cell typically has two electrodes of dissimilar materials separated from each other by an electrolyte. When connected to wiring through a load (e.g., the motor of an electric vehicle), a chemical reaction occurs between the electrodes through the electrolyte, causing electrons to flow from the negative electrode to the positive electrode to produce electricity that runs the load. Each electrochemical cell may include a pair of terminals, connected to an anode and cathode of the cell, respectively. One or more electrochemical cells may be connected to produce a battery, or a battery module (i.e., a battery pack, including one or more batteries).

In some embodiments, a first elongated member electrically connects a first terminal of at least one electrochemical cell to a second terminal of at least one other electrochemical cell, and a second elongated member electrically connects a third terminal of at least one electrochemical cell to a fourth terminal of at least one other electrochemical cell. In some embodiments, the first and second elongated members may be electrical busbars. In some embodiments, at least a portion of at least one of the first and second elongated members may include a hollow section. For example, one or both of the elongated members may be a hollow busbar, or may be a conduit or channel attached to a solid busbar. The hollow section of the elongated members may define a fluid pathway, configured to transmit a fluid (e.g., a dielectric thermal management fluid) for transferring heat to or from at least one of the pair of terminals of at least one of the plurality of electrochemical cells.

It should be noted that, although many of the examples described herein refer to thermal management fluid removing heat from the system, the same fluidic system may be used in other ways and for other purposes. For example, in some embodiments (e.g., in the case of lithium-based electrochemical cells), the fluid may also be used to transfer heat to the terminals, as well as to transfer heat away from them, to ensure a temperature within an ideal operating range for the electrochemical cells. In some embodiments, a heater (e.g., an immersion heater) may be introduced into the fluid pathway to provide heat to the terminals as needed. Any references to thermal management liquid, thermal management fluid, or other liquid elements made herein shall also include liquids which may be used for other purposes (e.g., supplying heat to the terminals). The examples provided are illustrative and not meant to be limiting.

Due to increasing demands being placed on battery modules (e.g., those used to power electric vehicles), the number of electrochemical cells used for some applications is growing. The power and current generated by these cells may create a significant amount of heat, which can adversely affect the performance of the systems and cause harm to electronics associated with the systems. Currently, there are a number of methods known for cooling battery modules, including direct air cooling (i.e., flowing air directly over the modules), direct liquid cooling (i.e., liquid is in direct contact with the modules), and indirect liquid cooling (i.e., liquid flows through channels adjacent to the modules, where heat is absorbed through the channel walls and conducted away). In direct liquid cooling, battery modules may be immersed in a dielectric fluid (e.g., 3M's Novec Engineered Fluid), which cools the modules without causing an electrical short. As the addition of any fluid can add weight and cost to a system, reducing the amount of fluid required while still providing adequate cooling for the system is highly desirable. Finally, as the density of the battery modules increases with the increased demand in power, void space between adjacent cells may be minimized or eliminated, removing access to the walls of interior cells for either air or liquid direct cooling methods.

In a battery module, significant amounts of electrical current may be passed through the busbars connecting the terminals in the electrochemical cells (e.g., during charging of the battery module.) This current results in a large thermal rise and gradient across the battery module. It will be shown herein that providing cooling at the terminals of the electrochemical cells is an effective means of cooling the entire battery module, as the terminals for each cell are electrically and thermally connected to the electrodes inside the cell itself, and provide an efficient pathway for the removal of internal heat (or for the supply of heat to the cell, in some cases). Prior art systems have not addressed such a cooling method, in part because of the large voltages that can exist across the terminals. However, as described herein, a dielectric (i.e., insulating) liquid can be passed through the elongated members connecting the terminals in the battery module. In addition, in some embodiments, the elongated members themselves may have sections which alternate between electrically conductive material and electrically insulating material. In some embodiments, the connection between the terminals and the elongated members may be thermally conductive, allowing heat to transmit from the terminals into the elongated members, where it may be absorbed and removed by a thermal management fluid (e.g., a liquid coolant), or, alternatively, allowing heat to transmit from the elongated members into the terminals (e.g., when system heating is required).

In some embodiments, the hollow section of an elongated member (and therefore the fluid pathway it defines) may extend for the entire length of the elongated member. In this manner, liquids may be routed through an elongated member connecting the terminals down the entire length of one side of a battery module (with a second elongated member doing the same for the other set of terminals on the other side of the battery module.) In some embodiments, the alternating sections of electrically conductive material and electrically insulating material can be used to connect the series of electrochemical cells in different configurations (e.g., in parallel, in series, or in some combination thereof.) In other embodiments, the hollow section may only extend for a portion of the elongated member. In some embodiments, the hollow section may include a fluid inlet and fluid outlet for the introduction and removal of a thermal management liquid.

In some aspects of the present description, an electrical power system is provided, including a plurality of electrochemical cells, a first elongated member, a second elongated member, a fluid pump, and a heat exchanger. Each cell of the plurality of electrochemical cells includes a pair of terminals, connected to an anode and cathode of the cell, respectively. In some embodiments, the first elongated member defines a first electrical connection between a first terminal of at least one of the electrochemical cells and a second terminal of at least one other electrochemical cell. The second elongated member defines a second electrical connection between a third terminal of at least one cell of the electrochemical cells and a fourth terminal of at least one other electrochemical cell. In some embodiments, at least a portion of at least one of the first and second elongated members comprises a hollow section, the hollow section defining a fluid pathway with the fluid pump and the heat exchanger. In some embodiments, a thermal management fluid may be transmitted through the fluid pathway, completing a circuit from the hollow section of the elongated members and the heat exchanger, driven by the fluid pump. In some embodiments, the heat exchanger may provide the heat removed from the power system to a conditioning loop for a vehicle cabin, where it may be used to provide heat to the occupants of the cabin. In some embodiments, the hollow section may extend for the entire length of one or both elongated members, allowing a thermal management fluid to flow through the hollow section, absorbing and removing heat from the terminals to which they are connected. In some embodiments, one or both elongated members may have alternating sections of electrically conductive and electrically insulating material, allowing various connection schemes and patterns to be employed among the terminals of the electrochemical cells, while still maintaining a pathway for fluid along the entire length of the elongated member. In some embodiments, the electrical power system further includes a dielectric liquid disposed inside the fluid pathway defined by the hollow section. In these embodiments, the use of an insulating, dielectric fluid prevents an electrical connection (i.e., shorting) between two terminals that are otherwise only connected by an electrically insulating section of the elongated member. In some embodiments, a heater may be introduced into the fluid pathway, such that additional heat can be added to the battery module (e.g., in extremely cold weather). For example, an immersion heater may be placed in the fluid pathway such that a thermal management fluid passes over and around it, absorbing heat which may be delivered to the battery module via absorption through the terminals of the electrochemical cells.

In some aspects of the present description, an electric power module is provided, including at least one electrochemical cell including a first terminal and a second terminal, a first electrically conductive member coupled to the first terminal, and a second electrically conductive member coupled to the second terminal. In some embodiments, at least a portion of at least one of the first electrically conductive member and the second electrically conductive member comprises a hollow section which defines a fluid pathway configured to transmit a fluid for transferring heat to or from at least one of the first and second terminals. In some embodiments, the electrically conductive members may be a busbar with a hollow section, or an electrically conductive conduit. In some embodiments, the connection between the terminal and the electrically conductive member may be thermally conductive, allowing heat to transmit from the terminal into the electrically conductive member, or heat to be supplied to the terminal from the electrically conductive member.

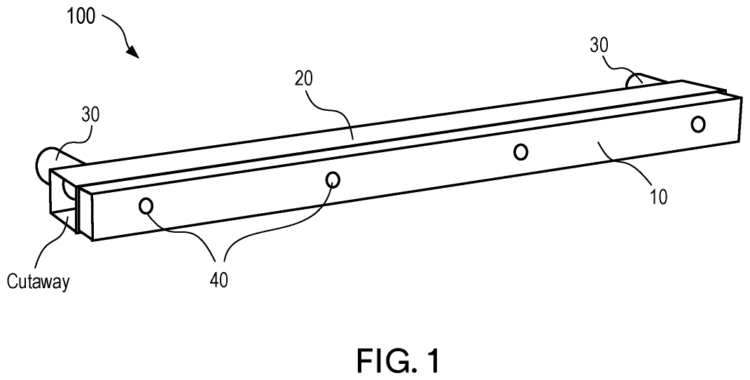

Turning now to the figures, FIG. 1 is a perspective view of an electrical connection with an integral fluid conduit, in accordance with an embodiment described herein. In some embodiments, an electrical connection may include a hollow section designed to transmit a thermal management fluid (e.g., a liquid coolant), for the purposes of removing heat emitted by the electrical terminals of a battery module (or, in some cases, providing heat to the terminals). In some embodiments, the electrical connection 100 may include a hollow conduit (e.g., a circular or rectangular channel) 20 attached to an electrical busbar 10. The conduit 20 may be attached to the busbar 10 via welding, mechanical attachment, thermally conductive adhesive, or any other appropriate attachment method. In some embodiments, a thermally conductive material (such as a thermal pad, thermally conductive adhesive, thermally conductive grease, etc., not shown) may be placed between the busbar 10 and conduit 20. In some embodiments, the material of the busbar 10, the conduit 20, or both may be thermally conductive. In some embodiments, conduit 20 has fluid ports 30 (e.g., a fluid inlet and/or outlet) which can be connected to a fluid supply so that a thermal management fluid may be passed through the conduit 30. It should be noted that conduit 20 is shown in FIG. 1 with a cutaway view on one end in order to illustrate its hollow nature. The cutaway end, shown here for illustration purposes only, would be covered or otherwise sealed in actual practice to prevent the loss of fluid. In some embodiments, threaded holes 40 are provided in busbar 10 to allow for attachment to the terminals of one or more electrochemical cells (not shown). For example, bolts may pass through corresponding holes in terminals and then be screwed into threaded holes 40. Alternatively, any known fastening mechanism may be employed to couple the busbar 10 to the terminals. Heat generated by the chemical reactions between electrodes inside the electrochemical cell, as well as heat generated in the busbar 10 as large amounts of current are passed through it, may be transmitted into conduit 20, where it is absorbed by fluid passing through conduit 20 and away from the cell (e.g., toward a heat exchanger or heat sink). In some embodiments, conduit 20 may be constructed of an electrically insulating, thermally conducting material. In other embodiments, conduit 20 may be made of an electrically conductive material. The embodiment of FIG. 1 is illustrative only, and not intended to be limiting. Other embodiments may exist without deviating from the intent of the present disclosure. For example, the conduit 20 and busbar 10 may be combined into a single electrically conductive conduit. Additional variations will be described in more detail in the discussion of later figures.

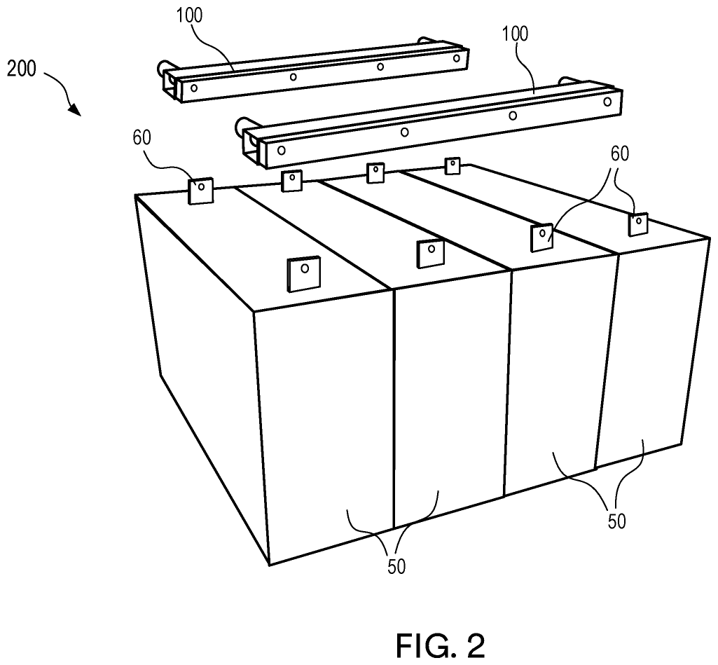

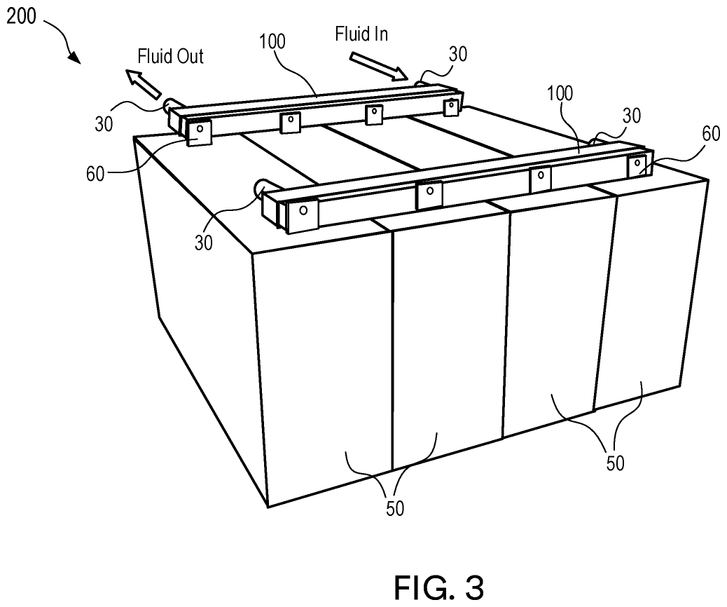

FIGS. 2 and 3 provide perspective views of a battery module in accordance with an embodiment described herein. FIG. 2 shows an exploded view of battery module 200 with one or more elongated members, such as the electrical connections 100 of FIG. 1. Battery module 200 includes a series of electrochemical cells 50, where each cell 50 includes a pair of electrical terminals 60. FIG. 3 shows the same battery module 200 with the elongated members 100 connected to terminals 60 of the electrochemical cells 50. In this embodiment, one elongated member 100 is attached to each of the terminals 60 on one side of the battery module 200, and the other is attached to each of the terminals 60 on the other side of battery module 200. Thermal management fluid (not shown but indicated by arrows showing flow direction) may be passed through the elongated members 100, entering through one fluid port 30 and exiting the other. As described elsewhere herein, heat from terminals 60 passes into the elongated members 100, where it is absorbed and transported away from the battery module via the fluid passing in elongated members 100 (or, conversely, heat may pass from elongated members 100 into terminals 60).

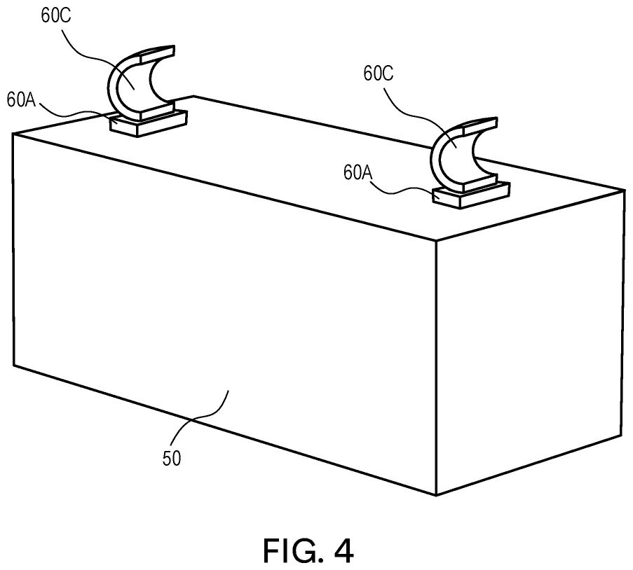

One type of electrochemical cell that is often used for electric vehicle applications is a prismatic cell (e.g., a lithium-ion prismatic cell). Prismatic automotive cells are electrochemical cells which contain electrodes in a stacked or layered form, often contained in a rectangular housing or “can.” These cells are often used because they have a thin design and can better utilize the available space, improving the density and capacity of battery modules. A typical prismatic automotive cell has flat, metallic terminal pads, allowing various types of connection hardware to be welded to them. In some embodiments of the present description, it may be advantageous to connect a fluid conduit directly to the terminals of an electrochemical cell, rather than connecting the conduit first to an electrical busbar. FIG. 4 provides a perspective view of an electrochemical cell with C-shaped connection points, in accordance with such an embodiment. In some embodiments, electrochemical cell 50 includes a pair of flat terminal pads 60A. As with the terminals 60 shown in previous figures, terminal pads 60A provide the same function, providing an external interface to the anode and cathode contained within the electrochemical cell 50. In the embodiment shown in FIG. 4, C-shaped connection points 60C are welded or otherwise attached to terminal pads 60A. Connection points 60C are electrically conducting, effectively extending the electrical connection from terminal pads 60A. In some embodiments, connection points 60C are also thermally conductive, conducting heat between terminal pads 60A and a fluid conduit connected to connection points 60C.

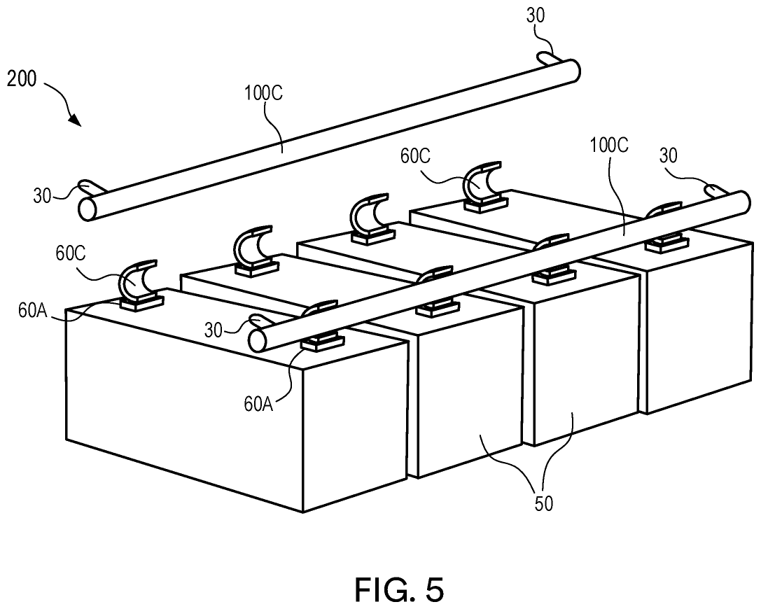

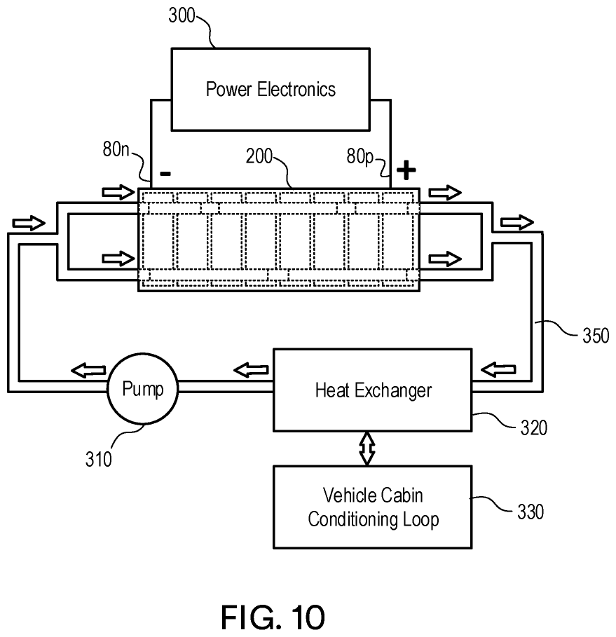

For example, FIG. 5 provides a partially exploded, perspective view of a battery module 200, including a number of electrochemical cells 50, each connected by hollow elongated members 100C (which serve as the electrical connections. In the embodiment shown, C-shaped connection points 60C are designed such that the shape of the “C” fits around the circumference of elongated members 100C, in the form of hollow cylindrical electrical connections. Cylindrical electrical connections 100C may be attached to C-shaped connection points 60C by any appropriate method, including, but not limited to, welding, mechanical connection hardware, thermally conductive adhesive, or a combination thereof. In some embodiments, the cylindrical electrical connections 100C are electrically conductive over their entire length, each connecting to two or more C-shaped connection points 60C (which are, in turn, connected electrically to terminal pads 60A). While elongated members 100C having circular cross sections and C-shaped connection points 60C are depicted, of course, elongated members having any cross-sectional shape and connection points shaped in accordance with any such elongated members may be employed. A liquid coolant or other thermal management fluid (not shown) may be directed through cylindrical electrical connections 100C, entering the hollow cylinder through one fluid port 30 and exiting through the other fluid port 30. In some embodiments, a fluid circuit, not shown, may be connected to fluid ports 30, including a pump to push fluid through the circuit and a heat exchanger to extract the heat from the fluid before rerouting it back through the fluid circuit. An example fluid circuit will be discussed in detail in FIG. 10. In some embodiments, the fluid circuit may include a heater, such that heat can be transmitted to terminals 60 through a thermal management fluid contained in electrical connections 100C, when the system requires additional heat.

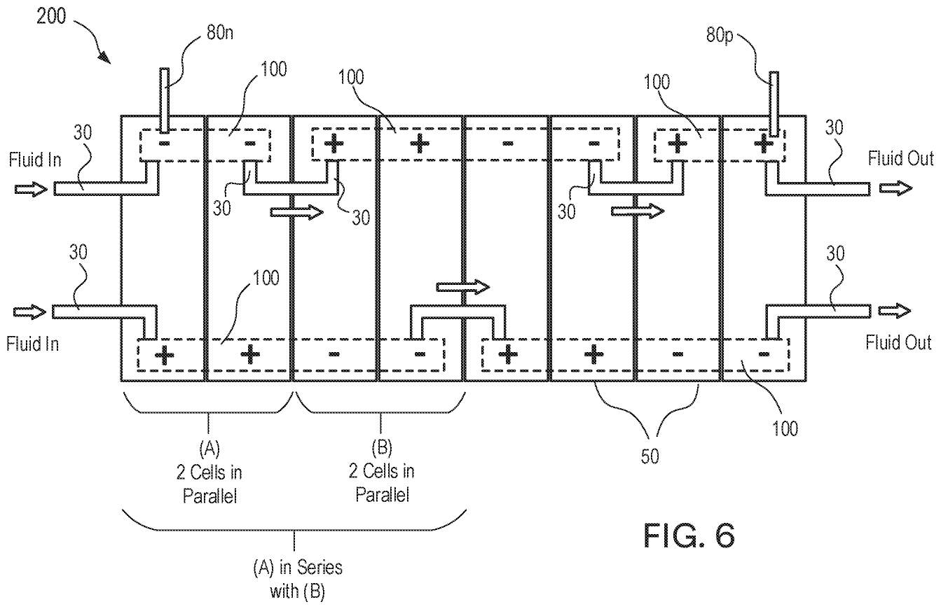

In the example embodiments discussed thus far, the battery modules have included a pair of elongated members (such as members 100 of FIG. 2, or members 100C of FIG. 5), with each elongated member connecting a series of cell terminals on one side of the battery module. However, it may be desirable to connect the terminals of a battery module using a series of shorter electrically conductive members separated by an insulating section or an air gap. For example, in the embodiment of FIG. 6, a top view of a battery module 200 illustrates, where, instead of a single, elongated member making electrical connections among the terminals on one side of the module, there are a series of shorter electrically conductive members 100 (shown by dashed lines to show the polarity of the underlying terminal) connecting subsets of the terminals to create a specific electrical configuration within the battery module. For example, in the embodiment of FIG. 6, there are eight electrochemical cells 50 shown. The cells 50 are arranged such that the terminals of each pair of adjacent cells are aligned (i.e., the polarity of the terminals in the pair of cells is aligned.) With reference to the first two cells in the module (i.e., starting on the left), it is shown that the two negative (−) terminals are electrically connected by one relatively short electrically conductive member 100, and the two positive (+) terminals are electrically connected by another electrically conductive member 100. This creates pair (A) of electrochemical cells 50 which are electrically in parallel with each other.

Similarly, the next two electrochemical cells 50 (pair (B)), are connected in parallel with each other. It should be noted that the positive terminals of pair (A) share an electrically conductive member 100 with the negative terminals of pair (B), such that pair (A) is in series with pair (B). The remaining electrochemical cells 50 in the example shown in FIG. 6 are similarly connected to complete the battery module 200. A pair of module terminals, 80n and 80p, provide electrical connections for the battery module (i.e., an electrical load, such as a motor for an electric vehicle, can be connected to module terminals 80n and 80p).

In the example embodiment shown, three electrically conductive members 100, separated by air gaps, connect the terminals on one side of the module 200 (the top side, as shown in FIG. 6), and two electrically conductive members 100 connect the terminals on the other side of the module (the bottom side, as shown in FIG. 6). This configuration of electrically conductive members 100, as well as the specific orientation or arrangement of electrochemical cells 50 shown here, is one example only and not meant to be limiting in any way. Any appropriate number of electrically conductive members 100 and any appropriate arrangement of electrochemical cells 50 may be used, depending on the specific requirements of the desired battery module.

As shown, each of the shorter electrically conductive members 100 shown in the embodiment of FIG. 6 may include two fluid ports 30, through which a thermal management liquid may be routed for the purpose of transporting heat to and from the terminals to which they are connected. In some embodiments, the fluid outlet 30 of one electrically conductive member 100 may be connected to the fluid inlet 30 of another member 100, creating a continuous fluid pathway along one side of the battery module, even though there is a discontinuous electrical pathway (i.e., due to the air gaps between adjacent members 100). In some embodiments, the fluid channels connecting a fluid port 30 on one electrically conductive member 100 to another fluid port 30 on a second electrically conductive member 100 are electrically insulating (i.e., do not provide an electrical connection between connected members 100).

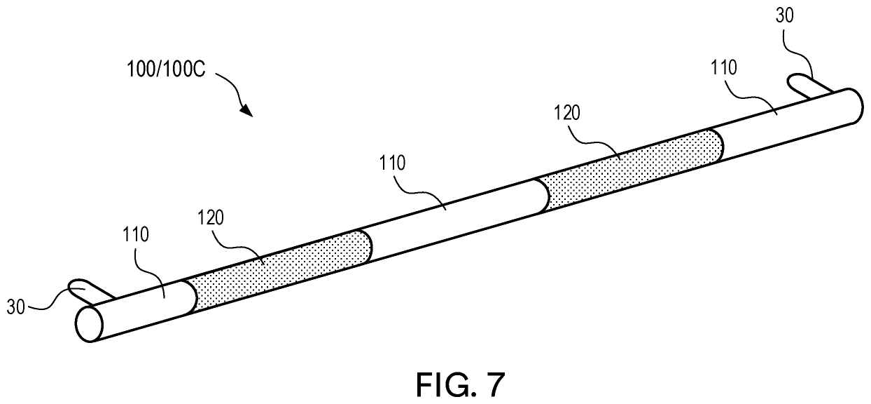

Connecting a series of shorter electrically conductive members 100 to create a continuous fluid pathway but a discontinuous electrical connection, as in the example embodiment of FIG. 6, creates a number of fluid connection points and conduits that could add additional labor costs or maintenance to the system. Consequently, it may be advantageous to replace the multiple electrically conductive members 100 in FIG. 6 with a single, connected conduit on each side of the module 200. A single, electrically conductive conduit, however, necessitates that all of the terminals on one side of battery module 200 be electrically connected (such as in the example embodiment of FIG. 3 or 5). To avoid such requirement, a single, elongated member (with a single, continuous hollow fluid pathway) constructed with alternating sections of electrically conductive material and electrically insulating material, as shown in FIG. 7, may be employed.

FIG. 7 shows an example embodiment of an elongated member 100 (or, alternatively, 100C) for connecting the terminals of a number of electrochemical cells, including sections of electrically insulating material 110 and sections of electrically conducting material 120. In some embodiments, alternating sections 110 and 120 together define a hollow section which extends for substantially the entire length of elongated member 100. A thermal management fluid may enter the hollow elongated member 100 through one of the fluid ports 30 and leave the member 100 through the other fluid port 30. In some embodiments, both the electrically insulating sections 110 and the electrically conductive sections 120 may be thermally conductive, such that heat produced in the terminals to which the elongated members 100 are connected will be conducted into the interior of the elongated members 100, where fluid flowing through the hollow section defined by the elongated members 100 will absorb the heat and transport it out of the members 100. In some embodiments, to prevent an electrical connection (i.e., a short) through the thermal management fluid across one of the electrically insulating sections 110, the thermal management fluid may be a dielectric (electrically insulating liquid).

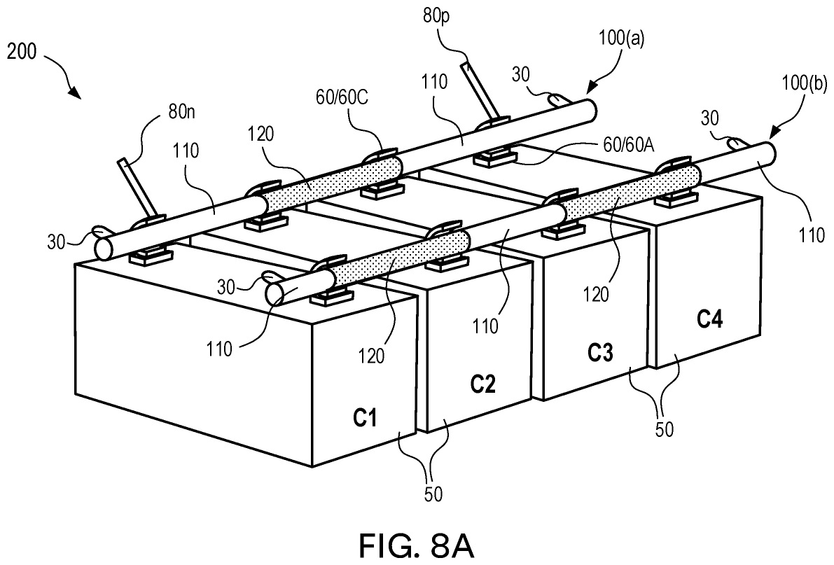

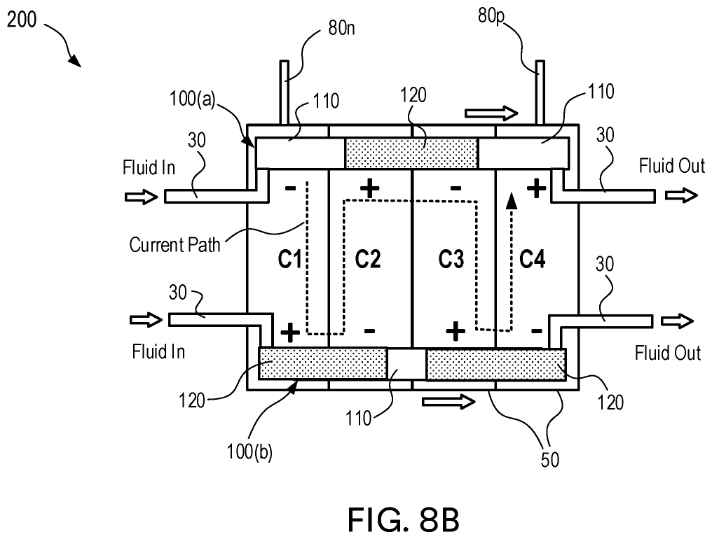

The pattern of alternating sections of insulating material 110 and conductive material 120 shown in the example embodiment of FIG. 7 is not limiting. Any appropriate pattern of insulating sections 110 and conductive sections 120 may be used as appropriate to create a terminal connection scheme for a battery module. For example, FIG. 8A provides a perspective view of an example battery module featuring electrical connections with integral cooling, using the elongated member 100 of FIG. 7. In the example shown, four electrochemical cells 50, labeled C1-C4, are connected to make battery module 200. Two elongated members 100 are used to connect the terminals 60 of the electrochemical cells 50, with one elongated member 100(a) on one side of battery module 200, and the other elongated member 100(b) on the other side of battery module 200.

Elongated member 100(a) includes two insulating sections 110 separated by a single electrically conductive section 120. The electrically conductive section 120 of elongated member 100(a) connects two terminals 60, one on cell C2 and one on cell C3, but, because of the electrically insulating sections 110, does not connect electrically with terminals 60 on cell C1 or cell C4. Although elongated member 100(a) only connects two of the electrochemical cells 50 electrically, elongated member 100(a) does connect all four cells 50 (C1-C4) thermally. In other words, while only one section of elongated member 100(a) is electrically conducting, the entire length of member 100(a) is thermally conducting. The hollow section inside member 100(a) transmits fluid along substantially the entire length of member 100(a), from one fluid port 30 to the other fluid port 30, and the fluid absorbs heat from the terminals 60 of all four electrochemical cells 50 (C1-C4) and removes it from the system (or, conversely, supplies heat to the terminals 60).

Similarly, elongated member 100(b) has two electrically conducting sections 120, alternating in position with three electrically insulating sections 110. One electrically conductive section 120 connects terminals 60 on cells C1 and C2, and the other electrically conductive section 120 connects terminals 60 on cells C3 and C4. As with member 100(a), substantially the entire length of member 100(b) is hollow, defining a fluid pathway for a thermal management fluid (e.g., a dielectric fluid).

FIG. 8B shows a top view of the battery module 200 of FIG. 8A, and includes the polarity of the terminals for this example embodiment. For simplicity, the terminals themselves are not shown in FIG. 8B (as they would be substantially obscured by elongated members 100(a) and 100(b)), but each terminal is represented by a “+” or “−” sign showing the polarity of the respective terminal. In the example of FIG. 8B, the electrochemical cells 50 are arranged such that the polarity of the terminals for each adjacent cell 50 is opposite that of the cells on either side (i.e., the orientation of the cells alternate). Module terminals 80n and 80p represent the electrical terminals for the entire battery module 200. When a load is connected between module terminals 80n and 80p, electrical current enters module terminal 80n (connected to the negative cell terminal of cell C1) and follows the current path defined by the dashed arrow in FIG. 8B. Current flows through cell C1 from the negative terminal (−) to the positive terminal (+), though the first electrically conducting section 120 of member 100(b) into the negative terminal (−) of cell C2, from the negative terminal (−) of C2 to the positive terminal (+) of C2, through the sole electrically conducting section 120 of member 100(a) to the positive terminal (+) of C3, and so on, until the current exits module 200 through the positive module terminal 80p. In some embodiments, a dielectric fluid flows through each member 100(a) and 100(b), entering in one fluid port 30 and exiting though the second fluid port 30.

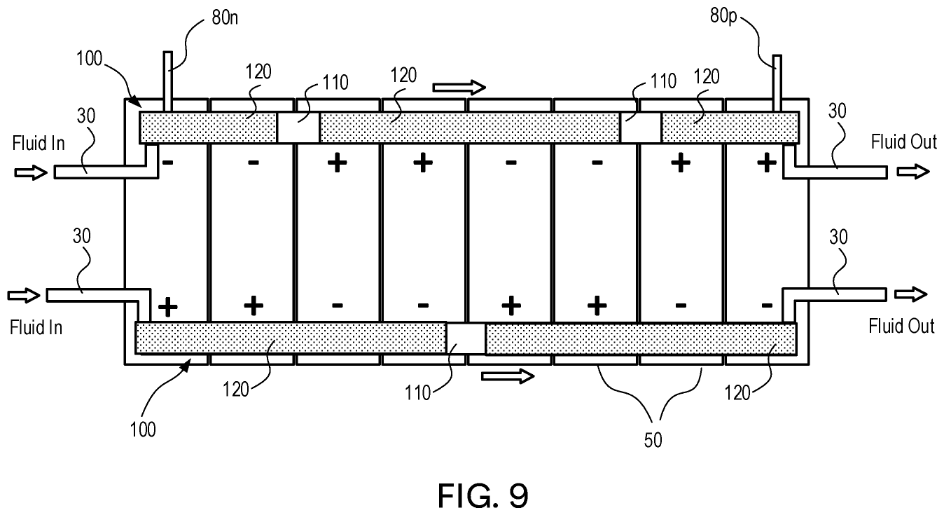

FIG. 9 is a top view of another example embodiment of a battery module using elongated members with alternating sections of electrically conductive and electrically insulating material.

This example is similar to the example of FIG. 8B, but with an alternate configuration of electrochemical cells 50 and elongated members 100. Components common to both FIG. 8B and FIG. 9 have like-numbered references and are assumed to function the same in both configurations, unless otherwise described herein.

The configuration of the embodiment of the battery module 200 of FIG. 9 is intended to match the configuration shown in FIG. 6. However, where FIG. 6 used a series of shorter, electrically conductive members to connect the terminals of battery module 200, FIG. 9 shows the same connections as made using a single elongated member 100 on each side of battery module 200. The elongated members 100 of FIG. 9 are analogous to the elongated members of FIG. 7, which include alternating sections of electrically insulating material 110 and electrically conductive material 120. While the embodiment of FIG. 6 electrically isolated the electrically conductive members from each other by an air gap, the embodiment of FIG. 9 uses electrically insulating sections 110 to provide electrical isolation of the connections. By replacing the air gaps of FIG. 6 with the electrically insulting sections 110 of FIG. 9, and by using a dielectric fluid as the thermal management fluid, each of the elongated members 100 of FIG. 9 can act as a single fluid channel for removing heat from the terminals of battery module 200. The number of fluid ports 30 and fluid connections required on each side of the battery module 200 may be reduced, and the amount of thermal management fluid required may be reduced relative to the embodiment of FIG. 6.

FIG. 10 is a block diagram of an electrical power system featuring electrical connections with integral cooling, in accordance with an embodiment described herein. Battery module 200 may be, for example, any of the example embodiments shown or described herein, including the configurations of FIGS. 3, 6, 8A-8B, and 9, although these configurations are examples only and not meant to be limiting. In some embodiments, battery module 200 has two module terminals 80n and 80p. Connected between module terminals 80n and 80p are an electrical load 300 (e.g., the power electronics controlling the motors of an electrical vehicle). In some embodiments, a fluidic circuit 350 is created by liquid conduits connected between the battery module 200, a heat exchanger 320, and a pump 310. Pump 310 causes the fluid (i.e., the thermal management fluid) to move through the fluidic circuit 350, passing through the battery module 200, where it collects heat from the terminals of the battery module 200 and removes it. The thermal management fluid then exits the battery module 200 and carries the excess heat to a heat exchanger, which removes the heat from the fluid and returns it to the fluidic circuit 350. The arrangement of the components shown in FIG. 10 is one possible configuration, and is not meant to be limiting. Variations of the system exist which do not vary from the scope or intent of the description. For example, as discussed elsewhere herein, an immersion heater or similar heat source may be introduced into fluidic circuit 350 for the purpose of heating the fluid to add heat to the battery module (e.g., in extreme cold conditions.)

In some embodiments, the heat exchanger 320 may interface to a conditioning loop 330 for a vehicle cabin or other appropriate application. For example, the heat exchanger 320 may pass heat recovered from the thermal management fluid of fluidic circuit 350 to the conditioning loop 330, which may use the heat to warm the environment within a vehicle cabin.

In some embodiments, suitable thermal management fluids may include or consist essentially of halogenated compounds or oils (e.g., mineral oils, synthetic oils, or silicone oils). In some embodiments, the halogenated compounds may include fluorinated compounds, chlorinated compounds, brominated compounds, or combinations thereof. In some embodiments, the halogenated compounds may include or consist essentially of fluorinated compounds. In some embodiments, the thermal management fluids may have an electrical conductivity (at 25 degrees Celsius) of less than about 1e-5 S/cm, less than about 1e-6 S/cm, less than 1e-7 S/cm, or less than about 1e-10 S/cm. In some embodiments, the thermal management fluids may have a dielectric constant that is less than about 25, less than about 15, or less than about 10, as measured in accordance with ASTM D150 at room temperature. In some embodiments, the thermal management fluids may have any one of, any combination of, or all of the following additional properties: sufficiently low melting point (e.g., <−40 degrees C.) and high boiling point (e.g., >80 degrees C. for single phase heat transfer), high thermal conductivity (e.g., >0.05 W/m-K), high specific heat capacity (e.g., >800 J/kg-K), low viscosity (e.g., <2 cSt at room temperature), and non-flammability (e.g., no closed cup flashpoint) or low flammability (e.g., flash point >100 F). In some embodiments, fluorinated compounds having such properties may include or consist of any one or combination of fluoroethers, fluorocarbons, fluoroketones, fluorosulfones, and fluoroolefins. In some embodiments fluorinated compounds having such properties may include or consist of partially fluorinated compounds, perfluorinated compounds, or a combination thereof.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

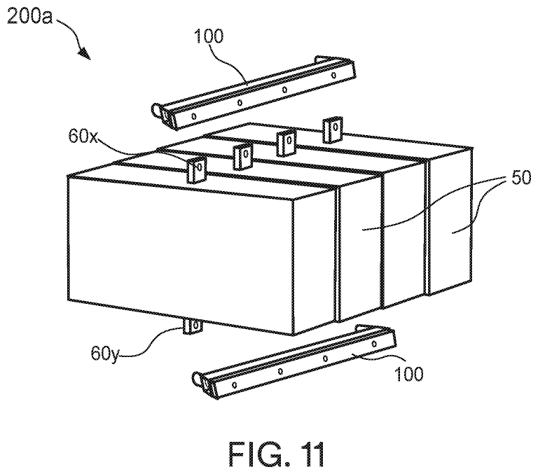

While the present disclosure has been described with respect to embodiments in which both terminals of a cell are disposed on the same side of the cell (and, therefore, cooling of the terminals occurs on the same side of each cell), it is to be appreciated that the terminals of any of the cells may be disposed on different (e.g., opposite) sides of the cell. For example, as shown in FIG. 11, each electrochemical cell 50 of battery module 200a may have a first terminal 60x on a first side of electrochemical cell 50 (e.g., a top side), and a second terminal 60y on a second side of electrochemical cell 50 (e.g., a bottom side). Accordingly, elongated members 100 may be disposed on different (e.g., opposite) sides of electrochemical cells 50, providing fluid pathways (and thus, cell cooling) on different sides of battery module 200a. Such embodiments may be particularly beneficial in eliminating or reducing temperature gradients that occur within cells that are cooled from a single side of the cell.

Also, while the examples of the present disclosure show rectangular, prismatic electrochemical cells, the same concepts apply equally to electrochemical cells of other shapes and/or configurations. For example, the electrochemical cells may be cylindrical cells, pouch cells, or any other appropriate type of cell or combination thereof. The concepts discussed in the present disclosure apply to battery modules with any appropriate number and/or configuration of electrochemical cells.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

### LISTING OF EMBODIMENTS

1. A battery module, comprising

a plurality of electrochemical cells, each cell of the plurality of electrochemical cells comprising a pair of terminals;

a first elongated member, electrically connecting a first terminal of at least one cell of the plurality of electrochemical cells to a second terminal of at least one other cell of the plurality of cells; and

a second elongated member, electrically connecting a third terminal of at least one cell of the plurality of electrochemical cells to a fourth terminal of at least one other cell of the plurality of cells;

wherein at least a portion of at least one of the first and second elongated members comprises a hollow section, the hollow section defining a fluid pathway configured to transmit a fluid for transferring heat to or from at least one of the pair of terminals of at least one of the plurality of electrochemical cells.

2. The battery module of embodiment 1, wherein at least a first portion of at least one of the first elongated member and the second elongated member is electrically conductive, and at least a second portion of the same elongated member is electrically insulating.

3. The battery module of any one of the previous embodiments, further comprising a thermal management fluid disposed within the fluid pathway.

4. The battery module of embodiment 3, wherein the thermal management fluid has an electrical conductivity less than 1e-7 S/cm.

5. The battery module of any one of embodiments 3 or 4, wherein the thermal management fluid comprises a halogenated fluid or an oil.

6. The battery module of any one of the previous embodiments, wherein the pair of terminals comprises a first terminal connected to an anode of the electrochemical cell, and a second terminal, connected to a cathode of the electrochemical cell.

7. The battery module of any one of the previous embodiments, wherein at least one of the first elongated member and the second elongated member comprises a cylindrical conduit.

8. The battery module of any one of the previous embodiments, wherein at least one of the first elongated member and the second elongated member further comprises an electrical busbar disposed on and adjacent to the fluid pathway.

9. The battery module of any one of the previous embodiments, wherein each terminal of the pair of terminals comprises a C-shaped member.

10. The battery module of any of the previous embodiments, wherein the fluid pathway comprises a fluid inlet and a fluid outlet.

11. The battery module of any of the previous embodiments, wherein at least one of the first elongated member and the second elongated member further comprises a series of shorter electrically conductive members separated by an insulating section.

12. The battery module of embodiment 11, wherein the insulating section is an air gap.

13. The battery module of any of the previous embodiments, wherein the hollow section extends along an entire length of the at least one of the first and second elongated members.

14. The battery module of any of the previous embodiments, further comprising a connection between at least one terminal and at least one of the first elongated member and the second elongated member, wherein the connection is thermally conductive.

15. The battery module of any one of embodiment 2-14, wherein the at least a second portion comprises a polymeric material.

16. The battery module of any one of embodiment 2-15, wherein the pair of terminals comprises a first-side terminal disposed on a first side of the electrochemical cell and a second-side terminal disposed on a second side of the electrochemical cell.

17. An electrical power system, comprising:

a plurality of electrochemical cells, each cell of the plurality of electrochemical cells comprising a pair of terminals;

a first elongated member, defining a first electrical connection between a first terminal of at least one cell of the plurality of electrochemical cells and a second terminal of at least one other cell of the plurality of cells;

a second elongated member, defining a second electrical connection between a third terminal of at least one cell of the plurality of electrochemical cells and a fourth terminal of at least one other cell of the plurality of cells;

a fluid pump; and

a heat exchanger;

wherein at least a portion of at least one of the first and second elongated members comprises a hollow section, the hollow section defining a fluid pathway with the fluid pump and the heat exchanger.

18. The electrical power system of embodiment 17, wherein at least a first portion of at least one of the first elongated member and the second elongated member is electrically conductive, and at least a second portion of the same elongated member is electrically insulating.

19. The electrical power system of any one of embodiments 17-18, further comprising a dielectric fluid disposed within the fluid pathway.

20. The electrical power system of any one of embodiments 17-19, wherein the pair of terminals comprises a first terminal connected to an anode of the electrochemical cell, and a second terminal, connected to a cathode of the electrochemical cell.

21. The electrical power system of any one of embodiment 17-20, wherein at least a portion of at least one of the first electrical connection and the second electrical connection is thermally conductive.

22. The electrical power system of any one of embodiment 17-21, further comprising a first module terminal and a second module terminal, the first module terminal and second module terminal connected to an electrical load.

23. The electrical power system of embodiment 22, wherein the electrical load is a motor for propelling an electrical vehicle.

24. The electrical power system of any one of embodiment 17-23, further comprising a heater, wherein the heater provides heat to the fluid pathway.

25. The electrical power system of any one of embodiments 17-24, wherein the pair of terminals comprises a first-side terminal disposed on a first side of the electrochemical cell and a second-side terminal disposed on a second side of the electrochemical cell.

26. An electric power module, comprising:

at least one electrochemical cell, comprising a first terminal and a second terminal;

a first electrically conductive member, coupled to the first terminal; and

a second electrically conductive member, coupled to the second terminal;

wherein at least a portion of at least one of the first electrically conductive member and the second conductive member comprises a hollow section, the hollow section defining a fluid pathway configured to transmit a fluid for transferring heat to or from at least one of the first and second terminals.

1. A battery module, comprising
a plurality of electrochemical cells, each cell of the plurality of electrochemical cells comprising a pair of terminals;
a first elongated member, electrically connecting a first terminal of at least one cell of the plurality of electrochemical cells to a second terminal of at least one other cell of the plurality of electrochemical cells; and
a second elongated member, electrically connecting a third terminal of at least one cell of the plurality of electrochemical cells to a fourth terminal of at least one other cell of the plurality of electrochemical cells;
wherein at least a portion of at least one of the first and second elongated members comprises a hollow section, the hollow section defining a fluid pathway configured to transmit a fluid for transferring heat to or from at least one of the pair of terminals of at least one of the plurality of electrochemical cells.

2. The battery module of claim 1, wherein at least a first portion of at least one of the first elongated member and the second elongated member is electrically conductive, and at least a second portion of the same elongated member is electrically insulating.

3. The battery module of claim 2, further comprising a thermal management fluid disposed within the fluid pathway.

4. The battery module of claim 3, wherein the thermal management fluid has an electrical conductivity less than 1e-7 S/cm.

5. The battery module of claim 3, wherein the thermal management fluid comprises a halogenated fluid or an oil.

6. The battery module of claim 1, wherein the pair of terminals comprises a first terminal connected to an anode of the cell of the plurality of electrochemical cells, and a second terminal, connected to a cathode of the cell of the plurality of electrochemical cells.

7. (canceled)

8. The battery module of claim 1, wherein at least one of the first elongated member and the second elongated member further comprises an electrical busbar disposed on and adjacent to the fluid pathway.

9. (canceled)

10. (canceled)

11. The battery module of claim 1, wherein at least one of the first elongated member and the second elongated member further comprises a series of shorter electrically conductive members separated by an insulating section.

12. (canceled)

13. The battery module of claim 1, wherein the hollow section extends along an entire length of the at least one of the first and second elongated members.

14. The battery module of claim 1, further comprising a connection between at least one terminal and at least one of the first elongated member and the second elongated member, wherein the connection is thermally conductive.

15. (canceled)

16. (canceled)

17. An electrical power system, comprising:
a plurality of electrochemical cells, each cell of the plurality of electrochemical cells comprising a pair of terminals;
a first elongated member, defining a first electrical connection between a first terminal of at least one cell of the plurality of electrochemical cells and a second terminal of at least one other cell of the plurality of electrochemical cells;
a second elongated member, defining a second electrical connection between a third terminal of at least one cell of the plurality of electrochemical cells and a fourth terminal of at least one other cell of the plurality of electrochemical cells;
a fluid pump; and
a heat exchanger;
wherein at least a portion of at least one of the first and second elongated members comprises a hollow section, the hollow section defining a fluid pathway with the fluid pump and the heat exchanger.

18. The electrical power system of claim 17, wherein at least a first portion of at least one of the first elongated member and the second elongated member is electrically conductive, and at least a second portion of the same elongated member is electrically insulating.

19. The electrical power system of claim 17, further comprising a dielectric fluid disposed within the fluid pathway.

20. The electrical power system of claim 17, wherein the pair of terminals comprises a first terminal connected to an anode of the cell of the plurality of electrochemical cells, and a second terminal, connected to a cathode of the cell of the plurality of electrochemical cells.

21. The electrical power system of claim 17, wherein at least a portion of at least one of the first electrical connection and the second electrical connection is thermally conductive.

22. The electrical power system of claim 17, further comprising a first module terminal and a second module terminal, the first module terminal and the second module terminal connected to an electrical load.

23. The electrical power system of claim 22, wherein the electrical load is a motor for propelling an electrical vehicle.

24. The electrical power system of claim 17, further comprising a heater, wherein the heater provides heat to the fluid pathway.

25. The electrical power system of claim 17, wherein the pair of terminals comprises a first-side terminal disposed on a first side of the electrochemical cell and a second-side terminal disposed on a second side of the electrochemical cell.

26. An electric power module, comprising:
at least one electrochemical cell, comprising a first terminal and a second terminal;
a first electrically conductive member, coupled to the first terminal; and
a second electrically conductive member, coupled to the second terminal;
wherein at least a portion of at least one of the first electrically conductive member and the second electrically conductive member comprises a hollow section, the hollow section defining a fluid pathway configured to transmit a fluid for transferring heat to or from at least one of the first and second terminals.
